(19) United States
(12) Patent Application Publication
(10) Pub. No.: US 2006/0271414 A1
(43) Pub. Date: Nov. 30, 2006

(54) System and method for processing an insurance application during a single user session

(76) Inventors: David A. Fenton, Delran, NJ (US); John A. Traynor, Lincroft, NJ (US); Eunice D. Silver, Wallingford, PA (US); Karen J. Carfagno, Newark, DE (US); Carol A. Weaver, Medford, NJ (US)

Correspondence Address: REED SMITH LLP, 2500 ONE LIBERTY PLACE, 1650 MARKET STREET, PHILADELPHIA, PA, 19103, US

(21) Appl. No.: 11/432,771

(22) Filed: May 11, 2006

Related U.S. Application Data
(63) Continuation of application No. 09/329,659, filed on Jun. 10, 1999.

(51) Int. Cl. G06Q 40/00

(52) U.S. Cl. 705/4

(57) ABSTRACT

A system and method for processing an insurance application during a single user session, wherein an application is received for a policy of insurance from a user over a computer network, the application is automatically approved or denied based on a comparison of the data contained in the application with stored underwriting criteria, a policy of insurance is automatically offered to the user in response to the application over the computer network if the application is approved and the policy is presented to the user for electronic acceptance, and the policy is issued upon electronic acceptance thereof by the user.

### CROSS-REFERENCE TO RELATED APPLICATIONS

This application claims priority to U.S. Utility application Ser. No. 09/329,659, filed Jun. 10, 1999, entitled “System and Method for Processing an insurance Application during a Single User Session,” which application is hereby incorporated by reference herein as if set forth in their entirety.

### FIELD OF THE INVENTION

The present invention relates generally to computer networks and more particularly to the sale of insurance over computer networks. Still more particularly, the present invention relates to the sale of insurance over the World Wide Web.

### BACKGROUND

One of the most important factors preventing individuals from purchasing insurance, particularly insurance covering less than catastrophic risks, is the cost of such insurance.

Although most individuals are risk averse and would be willing, and indeed eager, to pay a small premium over the actuarial value of their expected (average) losses in order to avoid the possibility of suffering large losses, they are less likely to pay the large premium required to purchase such insurance under present methods of selling insurance. Not only must the cost of insurance include the actuarial value of the expected loss, but also the insurer's operating costs relating to the policy, a reasonable profit for the insurer, an insurance agent's selling and operating costs relating to the policy, and a reasonable profit for the agent. Typically, the larger the value of the risk being insured, the less oppressive these additional costs are. For example, the agent's costs relating to selling a policy covering five thousand computers owned by a large corporation may not differ substantially from his costs in selling a policy relating to a single computer owned by an individual entrepreneur. If certain costs associated with the agent could be eliminated from the equation, however, many policies of insurance that are now uneconomical would become not only economical but very attractive to consumers.

An additional disincentive for purchasing insurance under present methods is the time and effort required to purchase a policy of insurance. An agent must be contacted and the appropriate forms obtained. These forms must then be filled out and submitted to the agent. Then the purchaser must wait until the insurer decides whether to issue the policy. If errors were made in filling out the forms, or if additional information is required, more paperwork and more waiting are necessary. Where a risk is substantial but less than catastrophic, an individual may be unwilling to purchase a policy of insurance due to the time and effort required to obtain such a policy. If a policy could be obtained conveniently and speedily, such an individual would be more likely to purchase it.

A third problem reducing the amount of insurance purchased by consumers is lack of knowledge of the availability of certain forms of insurance, such as insurance on individual home computers. If the availability of such insurance were more widely publicized, more individuals might purchase such insurance.

It is therefore an object of the present invention to provide a method and system for automating the insurance application process so as to avoid the necessity of the involvement of an insurance agent, thereby reducing the cost of insurance.

It is a further object of the present invention to provide a system and method for automating the insurance application process so as to allow a consumer to apply for and receive a policy of insurance speedily and easily.

It is a still further object of the present invention to provide a system and method for automating the insurance application process that will allow users to learn about the availability of such insurance through network resources such as Internet search engines and referral links.

These and other objects and advantages of the present invention will become more fully apparent from the description and claims that follow or may be learned from the practice of the invention.

### SUMMARY OF THE INVENTION

The present invention is directed to a computer-implemented system and method for processing an insurance application during a single user session. A user transmits an application for a policy of insurance over a computer network to a server. The application is then automatically approved or denied based on a comparison of the data contained in the application with stored underwriting criteria. If the application is approved, a policy of insurance is automatically offered to the user in response to the application. The policy is then presented to the user for electronic acceptance and is issued upon electronic acceptance thereof by the user.

### BRIEF DESCRIPTION OF THE DRAWINGS

FIG. 1 is a block diagram in accordance with a preferred embodiment of the present application.

FIG. 2 is a flow diagram showing the operation of an embodiment of the present invention.

FIG. 3 is a block diagram showing the organization of a World Wide Web site used in implementing a preferred embodiment of the present invention.

FIG. 4 is a schematic representation of an exemplary Web site homepage used in implementing a preferred embodiment of the present invention.

FIG. 5 is a schematic representation of an exemplary Web site page for obtaining a rate quote used in implementing a preferred embodiment of the present invention.

FIG. 6A is a schematic representation of an exemplary Web site page used in implementing a portion of the insurance application process in connection with a preferred embodiment of the present invention.

FIG. 6B is a schematic representation of an exemplary Web site page used in implementing a portion of the insurance application process in connection with a preferred embodiment of the present invention.

FIG. 6C is a schematic representation of an exemplary Web site page used in implementing a portion of the insurance application process in connection with a preferred embodiment of the present invention.

FIG. 6D is a schematic representation of an exemplary Web site page used in implementing a portion of the insurance application process in connection with a preferred embodiment of the present invention.

FIG. 6E is a schematic representation of an exemplary Web site page used in implementing a portion of the insurance application process in connection with a preferred embodiment of the present invention.

FIG. 6F is a schematic representation of an exemplary Web site page used in implementing a portion of the insurance application process in connection with a preferred embodiment of the present invention.

FIG. 6G is a schematic representation of an exemplary Web site page used in implementing a portion of the insurance application process in connection with a preferred embodiment of the present invention.

FIG. 7A is a schematic representation of an exemplary Web site page used in implementing a portion of the insurance application process in connection with a preferred embodiment of the present invention.

FIG. 7B is a schematic representation of an exemplary Web site page used in implementing a portion of the insurance application process in connection with a preferred embodiment of the present invention.

FIG. 7C is a schematic representation of an exemplary Web site page used in implementing a portion of the insurance application process in connection with a preferred embodiment of the present invention.

FIG. 7D is a schematic representation of an exemplary Web site page used in implementing a portion of the insurance application process in connection with a preferred embodiment of the present invention.

FIG. 7E is a schematic representation of an exemplary Web site page used in implementing a portion of the insurance application process in connection with a preferred embodiment of the present invention.

FIG. 7F is a schematic representation of an exemplary Web site page used in implementing a portion of the insurance application process in connection with a preferred embodiment of the present invention.

FIG. 7G is a schematic representation of an exemplary Web site page used in implementing a portion of the insurance application process in connection with a preferred embodiment of the present invention.

FIG. 8 is a schematic representation of a portion of an exemplary database used to store data relating inter alia to insurance policies in accordance with a preferred embodiment of the present invention.

### DETAILED DESCRIPTION OF THE INVENTION

Although all of the terms used in this application are well known to those of ordinary skill in the art, the following definitions are provided to aid in construing the claims of the present application:

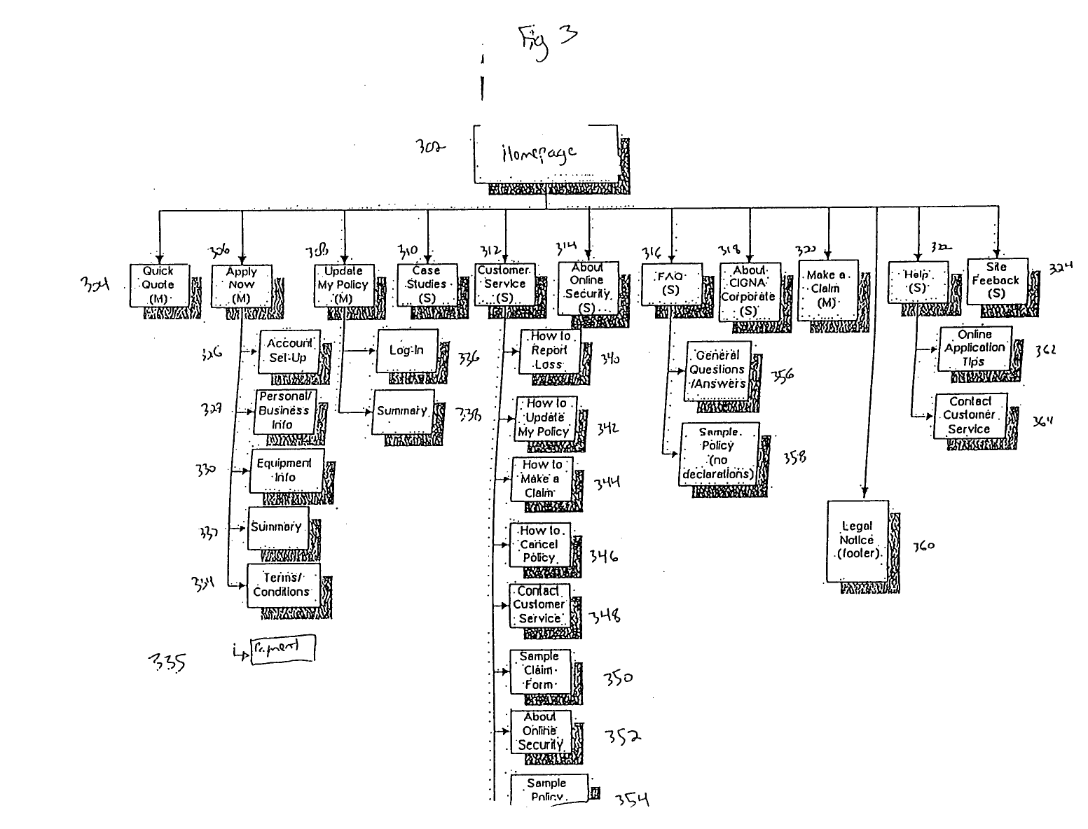

User session. A user session is the time during which two or more computers maintain a connection. With reference to the specific embodiments implemented in a World Wide Web [hereinafter the “Web”] environment and set forth in detail below, a user session is the time, after the connection of the user's computer, which may be a workstation or a terminal, to a Web server by an Internet connection and the launching of the user's Web browser, commencing when the user accesses any Web page within the Web site discussed in further detail below and illustrated in FIG. 3, continuing while the user is accessing any page on the Web (in any Web site), and terminating when the user ceases to access any page on the Web. For purposes of this definition, accessing a Web page includes not only the time during which data is being requested or downloaded from the appropriate Web server, but also the time during which (i) the relevant Web page is being displayed in a Web browser and (ii) the user's computer is connected to the Internet.

Computer network. A computer network is a group of computers and associated devices that are connected together by permanent connections, such as cables, or temporary connections, such as telephone links. Examples of computer networks are local area networks [hereinafter “LAN's”], wide area networks [hereinafter “WAN's’], the Internet, including the Web, on-line services, such as America-On-Line [hereinafter “AOL”], and intranets.

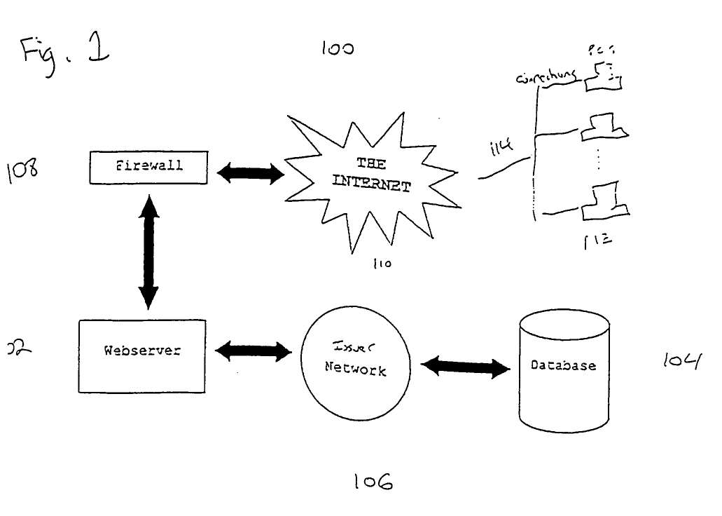

Referring now to FIG. 1, there is shown a block diagram of a preferred embodiment of a system for processing insurance applications over a computer network in a single user session 100. This embodiment [hereinafter the “PC Web Embodiment”] is directed more particularly to policies of insurance purchased over the Web on personal computers. A Web server 102, on which a Web site is stored, in html code and associated program code, is connected to a database 104, in which underwriting criteria are stored, by the issuer's network 106. The database may be a commercial-off-the-shelf relational database, such as oracle” version 7. The database is located on a computer other than the Web server in the PC Web Embodiment, but, depending on security considerations and the other needs of the issuer, may be located on the Web server itself.

The Web server 102 is also connected to the Internet 110 by a firewall 108 in the PC Web Embodiment. one skilled in the art will appreciate, however, that the firewall is not necessary for the functioning of the system and may be dispensed with if security is not an issue, or if the security features provided by the firewall are incorporated into other portions of the system, such as program code residing on the Web server. Multiple user computers 112, such as personal computers, are connected to the Internet by connections 114, which may be permanent connections, such as Ti lines, or temporary connections, such as those provided by modems operating over standard telephone lines.

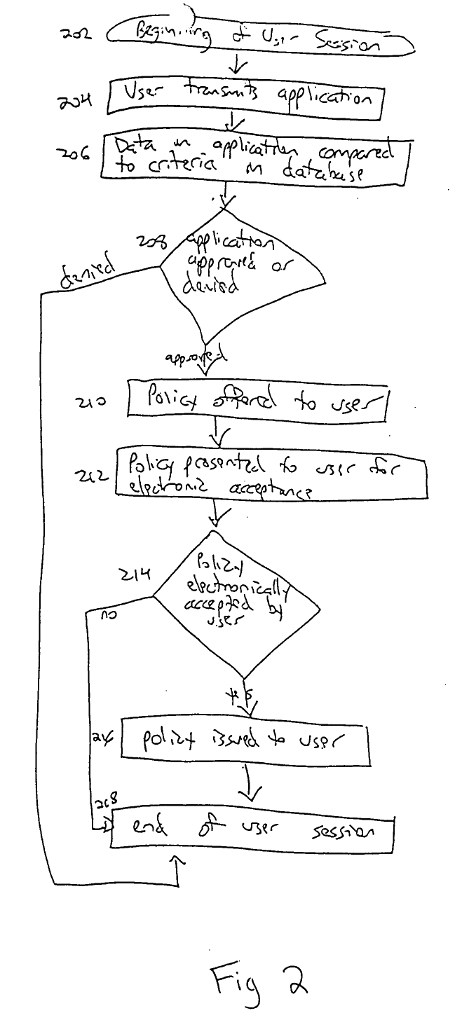

Referring to FIGS. 2, 3, 4, 5, 6A through 6G, and 7A through 7G, a preferred method of using the present invention is illustrated. In step 202, a user, such as an individual desiring to obtain a policy of insurance on his personal computer, commences a user session. In the PC Web Embodiment, the user will launch his Web browser, obtaining, if needed, a modem connection to the Internet, and cause a Web page within the Web site illustrated by FIG. 3 to be displayed. In other embodiments, a user might log onto an on-line service, such as AOL, or log onto a LAN or WAN. In step 204, the user then transmits an application for insurance to the Web server. In the PC Web Embodiment, the user transmits the application by viewing certain Web pages, described below, through his Web browser, from the Web site described in FIG. 3 and stored in Web server 102 (shown in FIG. 1) and entering certain information requested in such Web pages into his Web browser, which in turn transmits such information to the Web server.

For purposes of simplicity, viewing a Web page stored on a Web server will be described as “navigating” to that Web page, while the necessity of a Web browser's transmitting information entered into it to the Web server will be ignored. One skilled in the art will appreciate, however, that such omitted steps are included by implication in the following description.

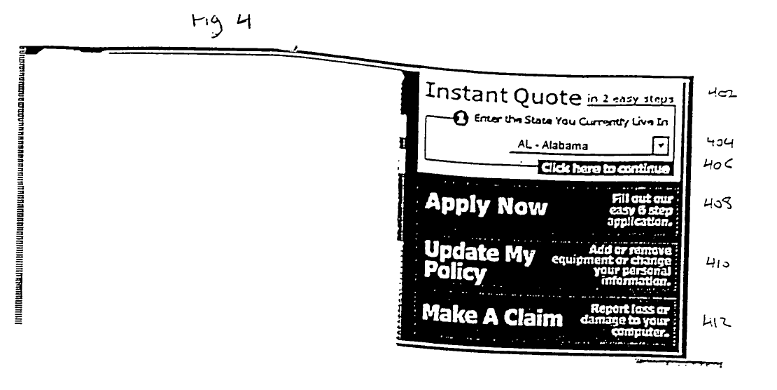

FIG. 4 displays an exemplary home page 302, which would represent the user's point of entry to the Web site. The user might navigate to this Web page by entering a Web address directly into his Web browser, by locating the Web address with an Internet search engine, or by selecting a link from another site, such as that of a co-marketer. In the PC Web Embodiment, such a co-marketer might be a direct marketer of personal computers, such as Dell or Gateway.

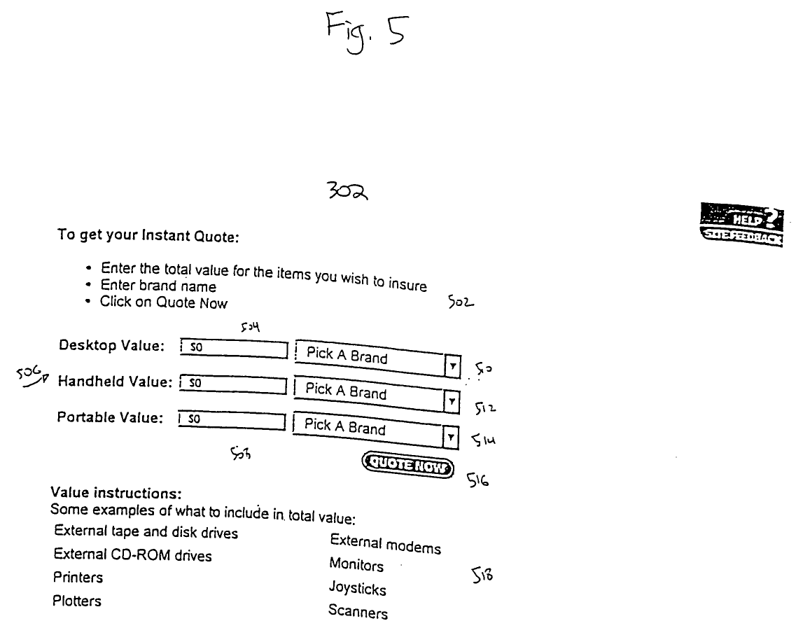

The exemplary home page 302 includes text instructing the user to select his state of residence 402, a drop down list box 404, from which the user may select his state of residence, and a clickable region 406, representing a link to an instant quote Web page 304 illustrated in FIG. 5. Clicking on region 406 after selection of the appropriate state of residence allows the user to indicate the value of his desktop, handheld, or portable computer in text box 504, 506, or 508, as may be appropriate, and to indicate the brand of his computer in drop down list box 510, 512, or 514, as may be appropriate. Clicking on region 516 will result in the user being provided with a preliminary quote for the annual cost of a policy of insurance on his computer. The system will compare the user's state of coverage, entered on Web page 302, and the computer type (desktop, handheld, or portable) and stated value entered on Web page 304, with certain criteria (see tables 1 and 2, infra) stored in database 104, code, or some combination of the database and code, to arrive at the preliminary quote. One skilled in the insurance arts will appreciate that handheld and portable computers are more likely to be damaged, lost, or stolen than desktop computers. Hence, application of the stored criteria to the submitted data might result in a preliminary quote equal to five percent of the value of a desktop computer and ten percent of the value of a portable computer. Moreover, geographic location might affect the cost of coverage. For example, loss due to theft might be more likely in an urban Northeastern state than in a more rural Midwestern one. Also, regulatory requirements of certain states might impose higher costs on policies issued with respect to those states.

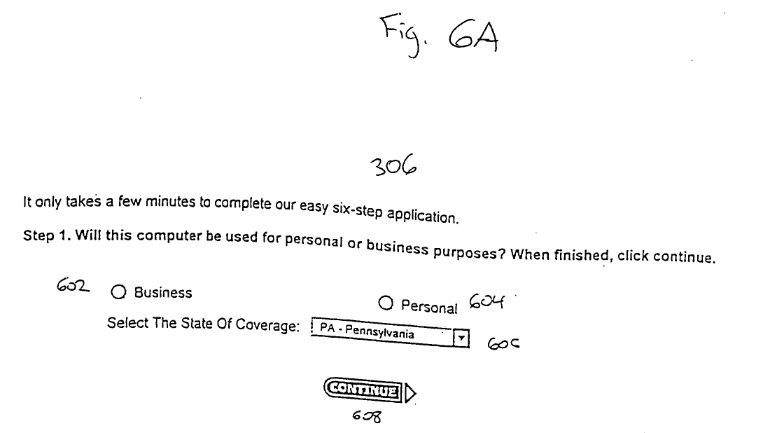

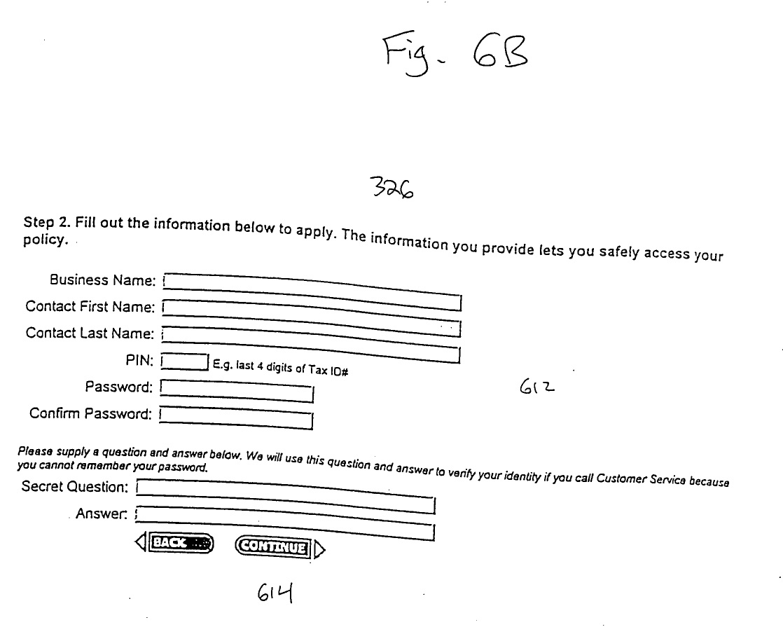

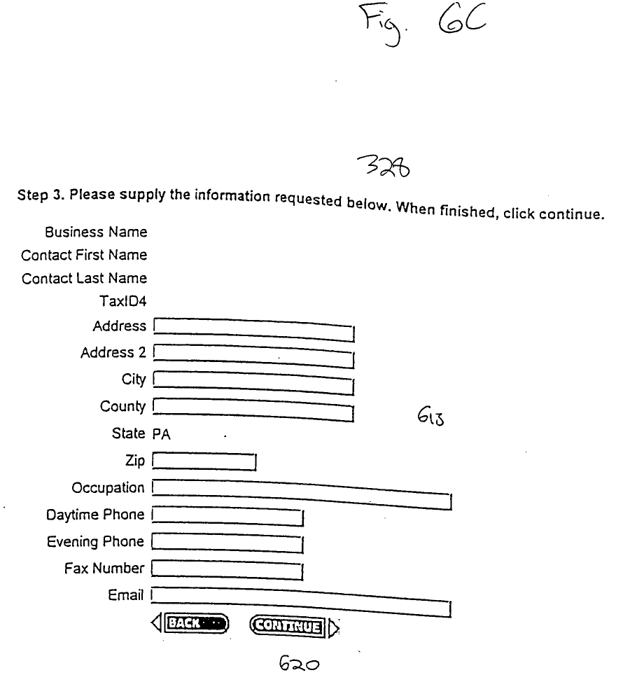

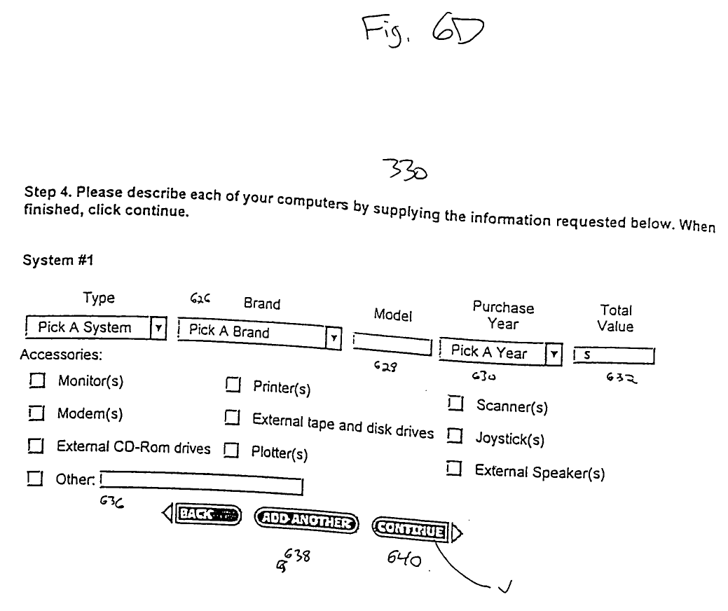

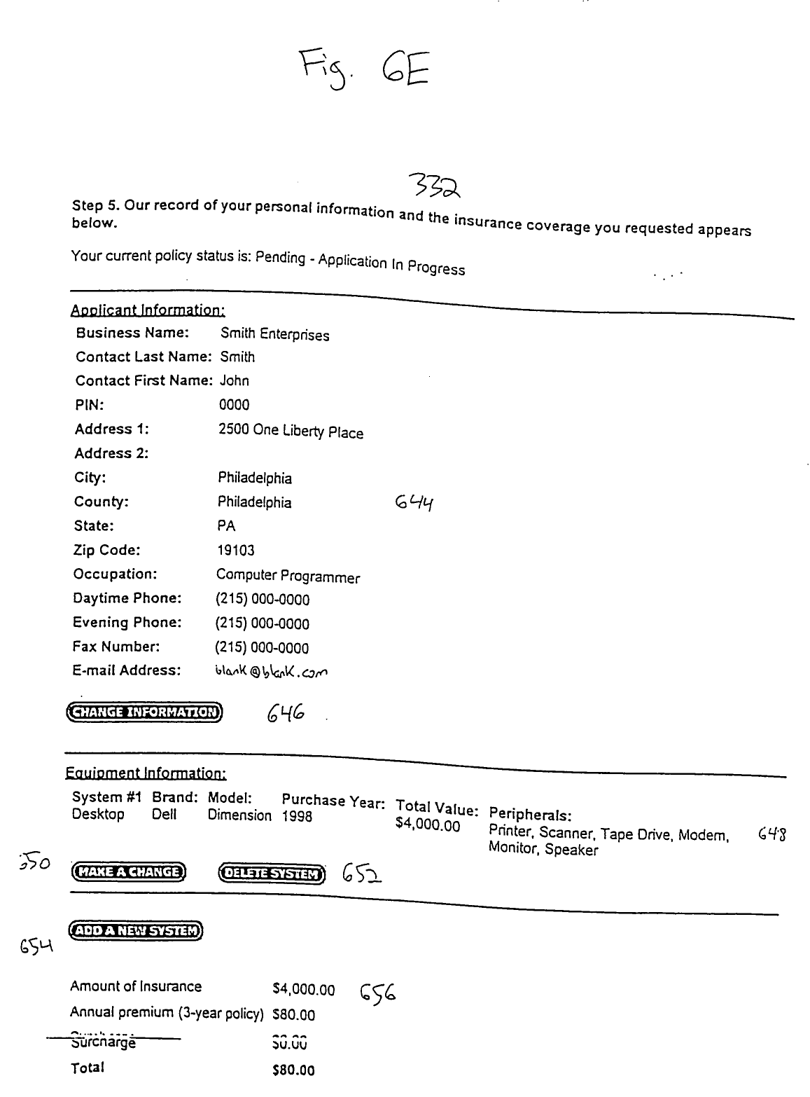

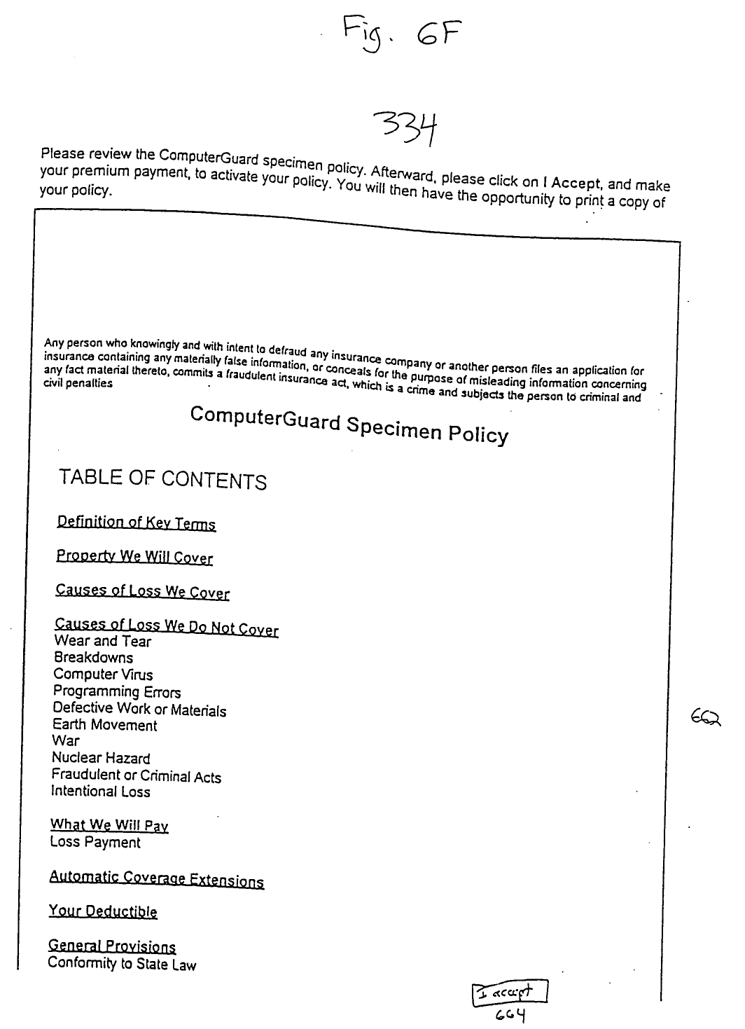

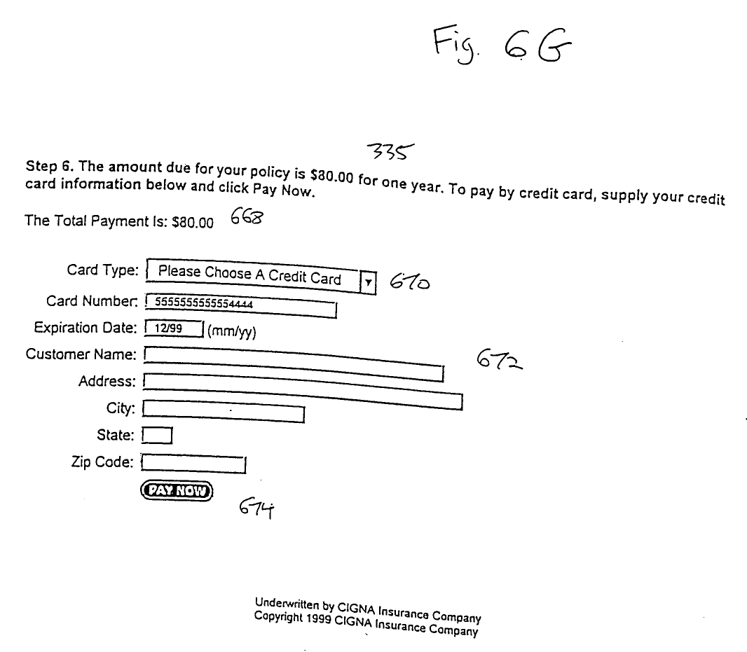

Returning to FIG. 4, the user is also provided with the choice of clicking on region 408, which represents a link to Web page 306, illustrated in FIG. 6A, in order to apply for a policy of insurance. The user must select radio button 602 or radio button 604 to indicate whether use of the computer to be insured is for personal or business purposes. This allows the following Web pages to prompt the user for the appropriate information. The user must also select the state of coverage in drop down list box 606. The user then clicks on region 608 which is a link to Web page 326. At this time, the chosen state is then compared to a list of states maintained in database 104 to determine whether the insurance product has been approved for use in that state. If the state is not on the list of approved states, the user is not permitted to proceed with the insurance application. Otherwise, Web page 326, illustrated in FIG. 6B, is displayed.

In the case of a business user, Web page 326 provides text boxes 612 in which a user must enter the name of the business, the name of a contact at the business, a personal identification number, a password, and a secret question and answer. The user may then click on region 614, which is a link to Web page 616 to proceed with the insurance application process. In the case of a personal user, the process is analogous, although the name of the user is entered instead of the business and contact names.

Web page 328 provides text boxes in which the user must enter his address, occupation, telephone and facsimile numbers, and e-mail address. The user may then click on region 620, which is a link to Web page 330 to proceed with the insurance application process.

Web page 330 requires a user to select a system (desktop, handheld, or portable), a brand (such as Dell or IBM), and a purchase year from drop down list boxes 624, 626, and 630 respectively and to enter a model and a total value into text boxes 628 and 632 respectively. In addition, the user may indicate the accessories that form a part of his computer system by checking as many of the check boxes 634 (such as monitor, printer, or scanner) as are applicable and by entering text into text box 636 if appropriate. The user may then enter data relating to another computer system to be insured at the same Web page by clicking on region 638 or may proceed to Web page 332 by clicking on region 640, which is a link to that Web page.

At this point, in the PC Web Embodiment, the system verifies that the amount of insurance sought to be obtained by the user is not excessive, based on criteria stored in code. In other embodiments having more numerous or more complicated criteria, such criteria would likely be stored in database 104. These criteria include a maximum value per system sought to be insured and a maximum value per insured. If the amount of insurance sought to be obtained is excessive, the user is provided with a text message to that effect and is offered an opportunity to re-enter lower values. If the amount is not excessive, the system displays Web page 332.

Web page 332 sets forth certain applicant information 644 and offers the applicant an opportunity to change such information by clicking on region 646, which is a link back to the applicant information data entry Web pages. The Web page also sets forth certain equipment information 648 and offers the applicant an opportunity to delete a system by clicking on region 652, to add a system by clicking on region 654, or to change information regarding a system by clicking on region 650, which is a link back to the equipment information data entry Web page.

The system then compares the data entered on Web pages 306 and 330 with criteria stored in database 104 to generate the amount of premiums due, in a manner analogous to the manner in which the preliminary quote was computed. However, the computation of the premiums due takes into account data not considered in determining the preliminary quote. In the PC Web Embodiment, the amount of the premiums due is equal to the amount of the preliminary quote. In other embodiments, however, the amount of premiums due may differ from any preliminary quote previously generated. The Web page then displays the amount of insurance previously selected by entering the computer system's value, as well as the premiums due, collectively 656. The applicant may continue by clicking on region 658, which is a link to Web page 334.

Clicking on region 658 completes step 204 of the application process and completes the transmission of the application to the issuer. At this point, the system compares the data contained in the application with certain underwriting criteria contained in database 104 or in code in step 206 (see FIG. 2). Although in the PC Web Embodiment certain data are compared with certain criteria at earlier stages of the application process (such as the maximum insurable value per system and per insured at Web page 330 and the state of coverage at Web page 306 as discussed above), in other embodiments, similar comparisons might be performed at this point. Also, the identity of the insured might optionally be checked against a list of frequent claimants to avoid fraudulent claims and a list of delinquent debtors to avoid credit losses, depending on the method of payment. Other comparisons with stored underwriting criteria could be performed as well, depending on the underwriting criteria ordinarily utilized by the insurer in question. Moreover, although in the PC Web Embodiment the maximum insurable value per system is stored in code, in an embodiment involving more complex or varied underwriting criteria, such criteria might be stored in a database.

In the case of a property insurance policy, the criteria might include the construction of the subject property, the occupancy of the subject property, public fire protection at the subject property, and prior loss activity with respect to the subject property. With respect to the construction criterion, the user might be presented with a list of generally accepted construction categories used in the property insurance industry, together with explanations of the categories. With respect to the occupancy criterion as well, the user might be presented with a list, in this case of occupancy ranges. With respect to the public fire protection criterion, the user might be presented with a list of such measures to check off or leave blank as applicable or a list of specific questions. With respect to the prior loss activity criterion, the user might be prompted to enter a total number of loss incidents and a total dollar amount of losses, as well as to answer a series of specific questions. The stored criteria might require denial of coverage or an increase in premiums depending on the data entered by the user.

In the case of a casualty insurance policy, the criteria might include operations, loss control measures, and prior loss history. With respect to the operations criterion, the user might be presented with a list of categories of operations, such as SIC categories. Preferably, however, the categories would be more specific than SIC categories. With respect to the loss control measures criterion, the user might be presented with a series of specific questions relating to whether and in what manner the applicant had instituted certain well known loss control measures that had proven effective in the relevant industry in the past. With respect to the prior loss activity criterion, the user might be prompted to enter a total number of loss incidents and a total dollar amount of losses, as well as to answer a series of specific questions.

In the case of a disability insurance policy, the criteria might include the applicant's age, medical history, and occupation. With respect to the age criterion, the user might be asked to enter the applicant's date of birth, allowing the system to compute the applicant's age with any required degree of specificity. With respect to the medical history criterion, the user would be presented with a series of specific questions relating to whether the applicant had ever suffered from various diseases and conditions, and the severity of such diseases and conditions. For example, the user might be asked whether the applicant had taken medication in the past year (or ever) relating to a condition, whether the applicant had been hospitalized in the past year (or ever) relating to that condition, and whether the applicant had been unable to work as a result of that condition in the past year (or ever). With respect to the occupation criterion, the user might be presented with a list of specific occupations.

In the case of an accidental death insurance policy, the criteria might include the applicant's age, which might be entered as discussed above.

In the case of a major medical insurance policy, the criteria might include the applicant's age and prior medical history, which might be entered as discussed above.

In any event, all of the criteria employed in connection with the evaluation of an application for any policy of insurance must be purely objective in nature so that the system may evaluate the application automatically without the need for human intervention. Examples of acceptable data that may be elicited by the system are selections from lists stored in database 104 (such as a stored list of occupations), yes or no answers to specific questions, numbers, and dates. other data may also be gathered from the applicant for claim processing or marketing purposes, but any narrative answers or non-objective data cannot be used in the application evaluation process.

Depending on the results of the comparison of the application data with the stored criteria in step 206, the system automatically approves or denies the application in step 208. The approval or denial of the application is based solely on an automated comparison of the entered data with the objective stored criteria. No human evaluation or intervention is necessary. If the application is denied, the user may be so informed by an appropriate message displayed on a Web page.

Optionally, the user may be given an opportunity to modify and resubmit the application in some embodiments.

If the application is approved, a policy will be offered to the user in step 210. The policy will then be presented to the user for electronic acceptance in step 212. In the PC Web Embodiment, steps 210 and 212 are combined and implemented with one Web page 334. The terms of the offered policy are displayed in region 662 (partially shown) on the Web page. In some states, the signature of an appropriate officer of the insurer is required to be included in the electronic policy. In such cases, a graphical object representing the officer's scanned signature is pasted into the policy. The user is given an opportunity to accept the policy electronically in step 214 by clicking on region 664, which is labeled “I accept”. Doing so results in the issuance of the policy to the user (step 216). The user may print or save the policy from his Web browser. In addition, the user may return to the Web site to view the policy at any time.

Also as part of step 214, in the PC Web Embodiment, the user is then required to submit sufficient information to pay the premiums due by major credit card on Web page 335. The amount of premiums due is displayed 668 and the user must select his type of credit card (such as Visa or American Express) from a drop down list box 670 and must fill in certain other data relating to his credit card in text boxes 672. The user must then click in region 674 to complete the application process. At this point, the credit card data may optionally be checked for validity. In other embodiments, payment might be required by electronic cash at the time of approval of the application, or payment might be allowed by check or otherwise after approval of the application. If payment is made, the insurance is automatically activated during the user session.

The user may then terminate his user session by closing his Web browser in step 218, or may continue to transact other related or unrelated business on the Web.

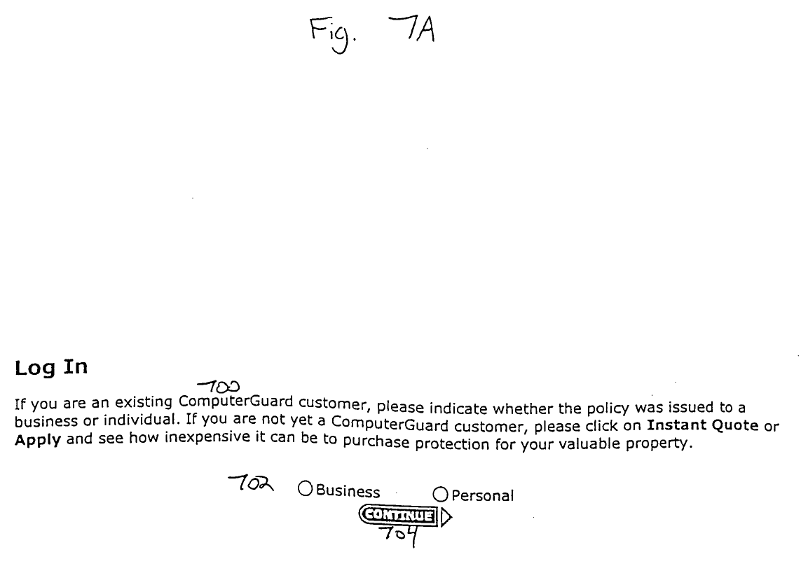

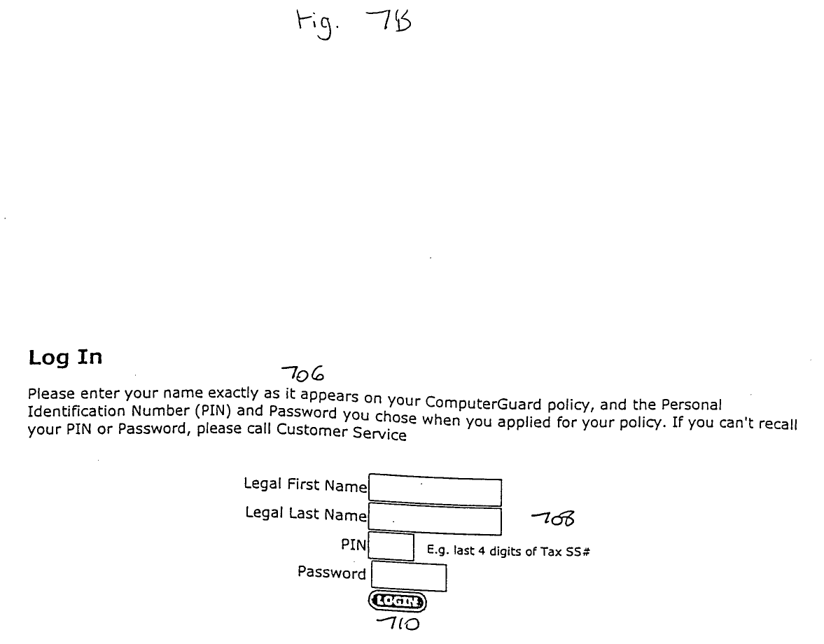

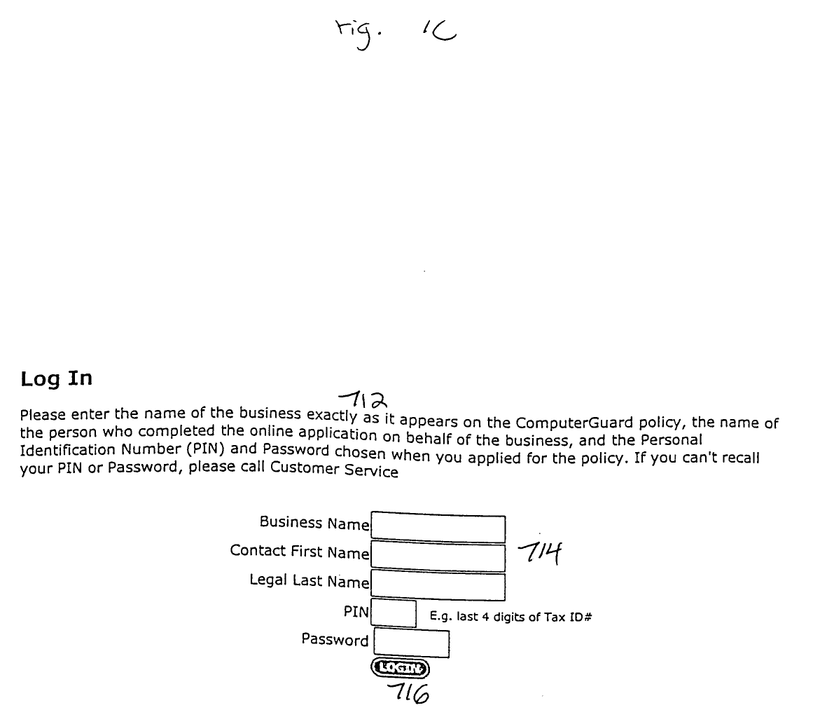

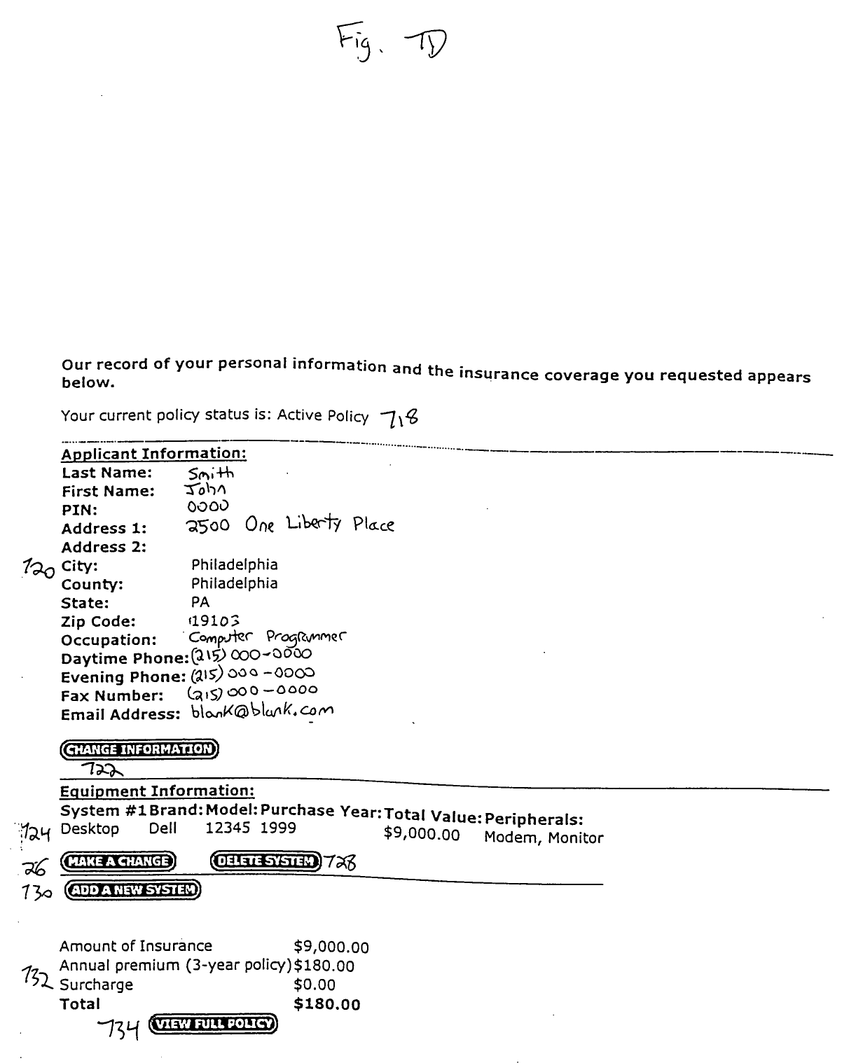

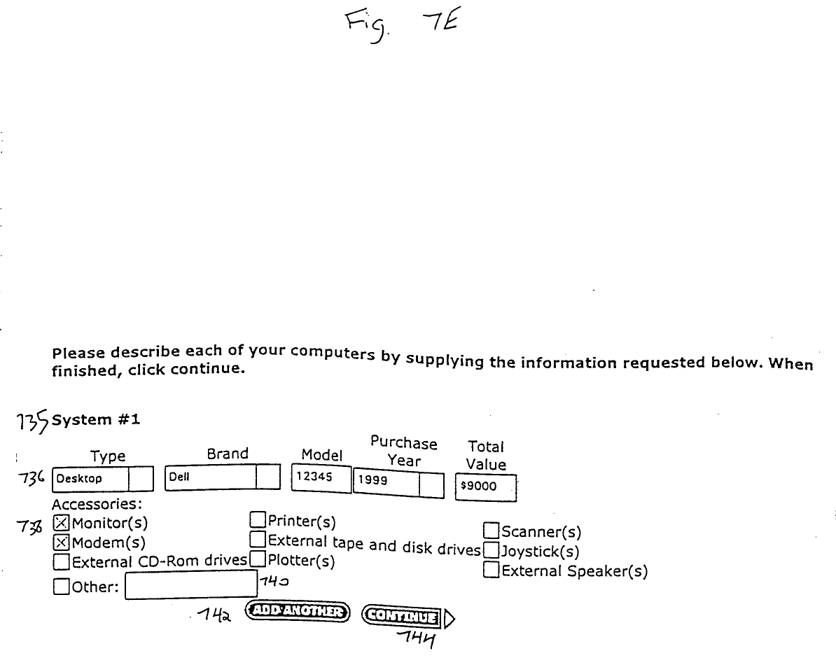

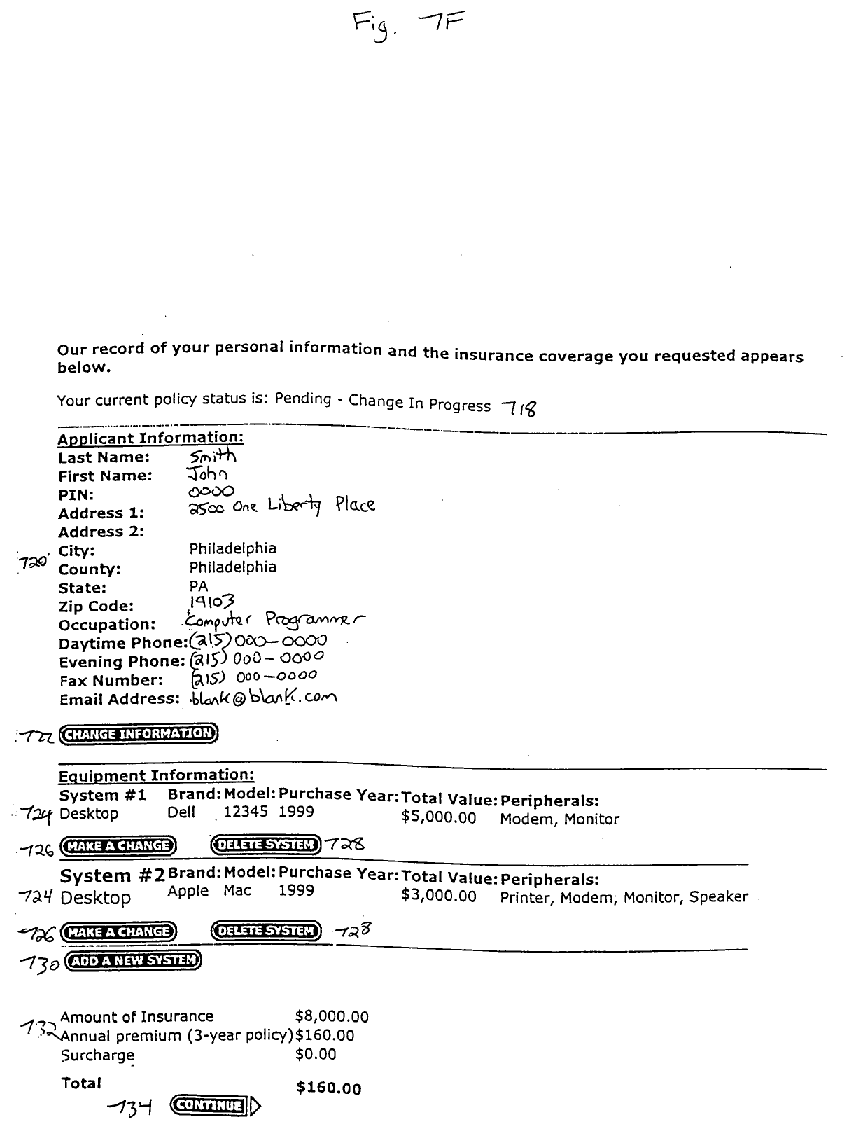

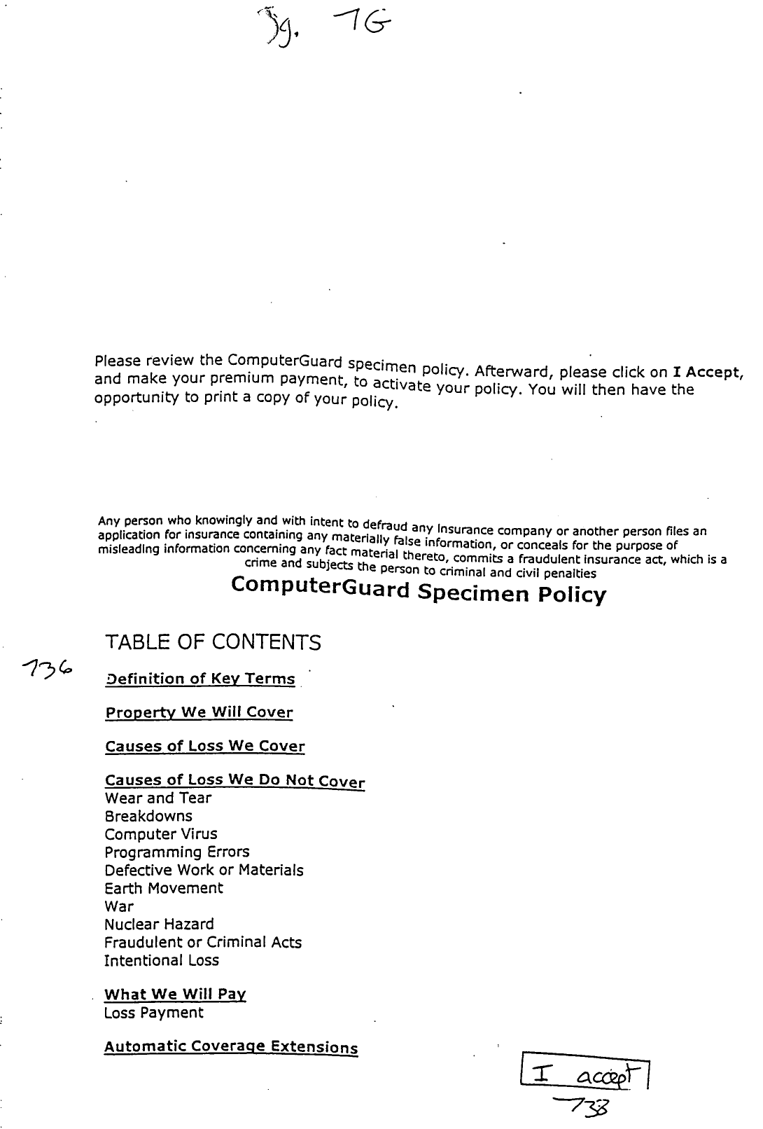

Referring to FIGS. 7A through 7G, the Web pages depicted therein permit a user in a preferred embodiment of the present invention to propose a modification to a previously issued policy in a manner analogous to the manner in which the data contained in applications may be modified, as described above.

However, the relationship of the effective date to the current date is also used as a criterion in determining whether to accept a proposed modification so as to prevent the predating of any modification to a policy. The modification is then accepted or denied after comparing the terms of the policy, as modified, to the criteria stored in database 104 or in code.

In more detail, the user may click on region 410 on Web page 302 in order to navigate to the Web page depicted in FIG. 7A. Text area 700 advises existing customers to click on the appropriate radio button in radio group 702 to indicate whether the user is a business or personal customer. Clicking on region 704 then causes either the screen shown in FIG. 7B (if the user is a personal customer) or the screen shown in FIG. 7C (if the user is a business user) to be displayed. Instructions to the user appear in either area 706 or 712, as is applicable, the user fills out the requested information in text boxes 708 or 714, as applicable, and clicks login button 710 or 716, as applicable.

In either case, clicking the applicable login button brings the user to the screen shown in FIG. 7D. The status of the existing policy is shown in area 718. Typically, the status of the policy will be either “active policy” or “pending—change in progress”. Area 720 sets forth information previously supplied by the user relating to the applicant, such as the applicant's name and address. Button 722 allows the user to navigate to Web page 328 to change this data, if necessary. summary information about the currently insured computer system (or systems) is shown in area 724, while buttons 726, 728, and 730 allow the user to change such information, delete a system, or add a system. Clicking on button 726 causes the screen set forth in FIG. 7E to be displayed with information pertaining to the presently selected system already displayed, while clicking on button 730 causes the same screen to be displayed, but without any such information. In region 732, a summary of the total amount insured and the total premiums is set forth. In addition, button 734 allows the user to view the user's current insurance policy.

If the user desires to add a system or modify data relating to a system, the screen shown in FIG. 7E is displayed after the user clicks on button 726 or button 730, as may be applicable. If the user is modifying data relating to an insured system, the currently stored data relating to that system is displayed in text and drop down list boxes 736, in check boxes 738, and in text box 740. If the user is adding a new system, text and drop down list boxes 736, check boxes 738, and text box 740 do not display data. In either case, region 735 identifies which system is being added or modified. Button 742 allows the user to add another system without first returning to the screen shown in FIG. 7D, while button 744 allows the user to continue on to the screen set forth in FIG. 7F (which is the same Web page as that of FIG. 7D, but with updated information).

FIG. 7F shows changed information submitted by a user in the course of requesting changes in an existing policy. Area 718 indicates that the change request is pending. Areas 724 contain data regarding two systems with a combined value less than that of the system originally insured. When the user clicks on button 734, the system determines whether to offer to issue an amended policy or to reject the change request based on underwriting criteria stored in database 104 or in code, as discussed above. If the underwriting criteria are met, an amended policy is displayed for inspection by the user as shown in part in FIG. 7G. The user may click on button 738 to accept this policy electronically. As is also discussed above, in certain embodiments, the user may be required to provide credit card information for payment at this time.

In the PC Web Embodiment, the user may not submit a claim online, but instead may print out a blank claim form from Web page 320 that may be sent by mail or facsimile to the issuer after completion. However, in other embodiments, electronic submission of claim forms might be permitted or required and electronic payment (in the form of electronic cash or by electronic funds transfer) might be permitted or required.

Tables 1 and 2 illustrate the data structure of database tables used for storing data relating to underwriting criteria. Neither table is used in the PC Web Embodiment, but either or both may be used in other embodiments in place of hard-coding criteria into the application code. The use of tables is especially advantageous when it is anticipated that the criteria (or their effect) may vary over time. For example, in an embodiment relating to medical insurance, the applicant may be denied a policy of insurance if he already suffers from certain serious diseases. This group of diseases may grow over time as new diseases are discovered and may shrink as new treatments are discovered. The use of tables would tend to minimize the need for recoding the application in such cases.

Table 1 describes tblRate, which is used to calculate a multiplier to be used in calculating premiums due in certain embodiments of the present invention. Each factor that would tend to affect the risk borne by the insurer is stored in the txtDescription field of a separate record in the table. A positive or negative number typically between 0 and 1 is stored in the fltRateValue field. During underwriting, the values stored in each applicable fltRateValue field are summed together and added to 1 to form a multiplier, which is multiplied by the normal insurance rate for such insurance, stored elsewhere in the database or in code and multiplied by the amount of insurance requested. Depending on the number and magnitude of the criteria capable of reducing premiums due, it may be necessary to verify that the multiplier is a positive number greater than zero.

TABLE 1
tblRate

| Field | Type | Description |
|---|---|---|
| intCriteriaID | Integer | Identification number for each criterion; |
| | | key field for table |
| txtDescription | Text | Description of criterion |
| fltRateValue | Real | Modification to premium if criterion applicable |

The database table described in table 2, namely tblBar, is similar, except that instead of storing a value used in determining a multiplier in the third field, an indicator indicating whether or not a policy may be issued is stored in the third field. If an underwriting criterion applies, tblBar is used to determine whether a policy of insurance may nonetheless be issued. During underwriting, tblBar is consulted with respect to each applicable criterion. If the indicator in the logBar field for any one of the applicable criteria indicates that a policy may not be issued, then the insurer will decline to issue a policy, regardless of the values of the logBar fields with respect to the other criteria.

If both tblRate and tblBar are utilized in a particular embodiment of the present invention, they are related in a one to one relationship through a join on the first (id) field of each table. Of course, the two tables could be combined into one table by joining them on the first (id) field, or only one of the two tables could be used, depending on the particular circumstances of the embodiment of the invention.

TABLE 2
tblBar

| Field | Type | Description |
|---|---|---|
| intBarID | Integer | Identification number for each criterion; |
| | | key field for table |
| txtDescription | Text | Description of criterion |
| logBar | Boolean | Indicates whether issuance of a policy |
| | | is barred if criterion is applicable |

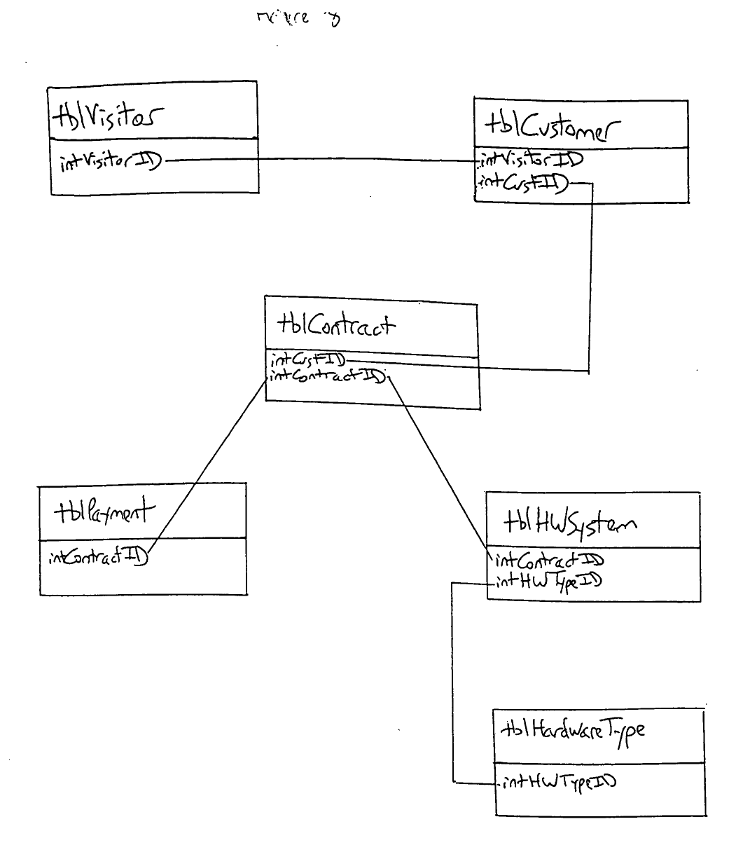

FIG. 8 illustrates the interconnections between several tables, summarized herein in tables 3 through 8, that form a part of an exemplary database used in implementing the PC Web Embodiment. Table tblVisitor (see table 3) stores an identification number for each user who visits the web site, as well as the identification number of any entity that referred the user to the web site.

Table tblCustomer (see table 4) is related to table tblVisitor by the common field intVisitorID, which is the key field of table tblvisitor. Several records in table tblCustomer may relate to a single record in table tblVisitor, but all such records relate to the same customer. Table tblCustomer stores a variety of information relating to each customer, such as information entered by a user in FIG. 6B or 6C. Each time that the user edits this body of information a new record is created and the number stored in the field intLogEntryID is incremented. Thus, each version of the user's data is preserved in chronological order and may be accessed by the insurer's personnel. Many of the other tables in the database also include intLogEntryID fields for the same purpose.

Table tblContract (see table 5) is related to table tblCustomer through the common field intCustID. Although only one active customer record should exist for each customer (any prior versions of contract records being retained for audit purposes only), more than one. contract can exist for each customer. Thus, the two tables are related in a one-to-many relationship. Table tblContract contains data such as the date each policy took effect, premiums due with respect to the policy, and the amount of insurance purchased.

Table tblPayment (see table 6) is related through the common field intContractID, which is the key field of table tblContract. Because many payment records can relate to a single contract, this relationship is also a one-to-many relationship. Table tblPayment contains such data as the date and amount of a payment, the method used to make the payment, and identification numbers relating to payments by credit cards.

Table tb1HWSystem (see table 7) is related to table tblContract by the common field intContractID, which is the key field of table tblContract. Because many hardware system records can relate to a single contract, this relationship is also a one-to-many relationship. Table tb1HWSystem contains the model number and year of purchase of a system as well as a number of fields that indicate whether specific items of hardware are included in a system, all of which data is entered by the user from Web page 330. The table also includes the amount of coverage purchased for the system, the date the system was first covered, and the date the coverage was last altered.

Table tblHardwareType (see table 8) is related to table tblHWSystem by the common field intHWTypeID, which is the key field of table tblHardwareType. Table tblHardwareType contains data describing the computer model used in the system and indicating whether the model is currently insurable.

TABLE 3
tblvisitor

| Field | Type | Description |
|---|---|---|
| intVisitorID | Integer | Identification number, key field |
| intReferrerID | Integer | Key field of another table |

TABLE 4
tblCustomer

| Field | Type | Description |
|---|---|---|
| intCustID | Integer | Identification number; key field |
| intCustTypeID | Integer | Key field of another table |
| intEmployeeID | Integer | Key field of another table |
| intVisitorID | Integer | Key field of another table |
| intStateID | Integer | Key field of another table |
| dtmCustEffDate | Date/Time | Date as of which information |
| | | in this table is valid |
| intLogEntryID | Integer | Indicates which version of |
| | | customer data is stored in a record |
| txtCustPIN | Text | Customer's personal identification |
| | | number |
| txtCustPassword | Text | Customer's password |
| txtCustFirstName | Text | Customer's first name |
| txtCustLastName | Text | Customer's last name |
| txtCustPasswordHint | Text | Customer's secret question |
| txtCustPassWordAnswer | Text | Customer's secret answer |
| logCustLockout | Boolean | Indicates whether the customer's |
| | | records have been locked due to |
| | | repeated invalid attempts |
| | | to access them |
| logCustNewOffersNotify | Boolean | Indicates whether the customer |
| | | desires to be notified of new offers |
| txtCustoccupation | Text | Customer's occupation |
| txtCustCompanyName | Text | Customer's company |
| txtCustAddressI | Text | First line of customer's address |
| txtCustAddress2 | Text | Second line of customer's address |
| txtCustcity | Text | customer's city |
| txtcustzip | Text | Customer's ZIP code |
| txtCustEmail | Text | Customer's e-mail address |
| txtCustCounty | Text | Customer's county |
| txtCustDayPhone | Text | Customer's daytime telephone |
| | | number |
| txtCustNightPhone | Text | Customer's nighttime telephone |
| | | number |
| txtCustFax | Text | Customer's facsimile number |

TABLE 5
tblContract

| Field | Type | Description |
|---|---|---|
| intcontractID | Integer | Identification number; key field |
| intActiveStatusID | Integer | Key field of another table |
| intCustID | Integer | Key field of another table |
| intStateID | Integer | Key field of another table |
| intEmployeeID | Integer | Key field of another table |
| dtmContractModifyDate | Date/Time | Date contract last modified |
| intLogEntryID | Integer | Indicates which version of |
| | | contract data is stored |
| | | in a record |
| dtmContractEffDate | Date/Time | Date this version of policy took |
| | | effect |
| dtmContractOriginDate | Date/Time | Date policy took effect |
| txtContractCompanyCode | Text | Code identifying type of policy |
| dtmContractExpDate | Date/Time | Date policy will expire |
| logContractManualSet | Boolean | Indicates whether change was |
| | | made manually by an employee |
| curContractOriginPremium | Currency | Original premium for policy |
| dtmContractManualSetDate | Date/Time | Date policy was changed |
| | | manually by an employee |
| intContractInstallments | Integer | Number of installments in which |
| | | premiums are to be paid |
| curContractDelta | Currency | Amount by which value of |
| | | policy may be changed without |
| | | changing premiums due |
| curContractAmount | Currency | Amount of insurance |
| curContractPremium | Currency | Amount of premiums |

TABLE 6
tblPayment

| Field | Type | Description |
|---|---|---|
| intPaymentID | Integer | Identification number; key |
| | | field |
| intContractID | Integer | Key field of another table |
| intEmployeeID | Integer | Key field of another table |
| intPaymentStatusID | Integer | Key field of another table |
| intPaymentMethodID | Integer | Key field of another table |
| curPaymentAmount | Currency | Amount of this payment |
| intLogEntryID | Integer | Indicates to which payment |
| | | data stored in this record |
| | | relate |
| intPaymentInstallment | Integer | Indicates to which |
| | | installment of a series of |
| | | installments payment |
| | | relates |
| dtmPaymentDate | Date/Time | Date of this payment |
| txtPaymentType | Text | Type of this payment (e.g., |
| | | by credit card) |
| intPaymentAttempts | Integer | Number of attempts to make |
| | | this payment |
| txtPaymentCCOrderID | Text | Identification number for |
| | | payment made by credit card |
| txtPaymentCCAuthorizeID | Text | Authorization number issued |
| | | by credit card issuer for |
| | | payment made by credit card |

TABLE 7
tb1HWSystem

| Field | Type | Description |
|---|---|---|
| intHWSystemID | Integer | Identification number; key |
| | | field |
| intContractID | Integer | Key field of another table |
| intHWMfrID | Integer | Key field of another table |
| intHWTypeID | Integer | Key field of another table |
| intActiveStatusID | Integer | Key field of another table |
| curHWSystemPremium | Currency | Premium due on this |
| | | system alone |
| intLogEntryID | Integer | Indicates which version of |
| | | system hardware data is |
| | | stored in a record |
| curHWSystemCoverageAmount | Currency | Amount of insurance on |
| | | this system alone |
| logHWSystemPrinter | Boolean | Indicates whether system |
| | | includes a printer |
| dtmHWSystemEffDate | Date/Time | Date this system first |
| | | covered by policy |
| txtHWSystemPurchYear | Text | Year of purchase of this |
| | | system |
| logHWSystemScanner | Boolean | Indicates whether system |
| | | includes a scanner |
| txtHWSystemModelNo | Text | Model number of computer |
| | | system |
| logHWSystemTapeDrive | Boolean | Indicates whether system |
| | | includes a tape drive |
| logHWSystemCDROM | Boolean | Indicates whether system |
| | | includes a CD-ROM drive |
| logHWSystemPlotter | Boolean | Indicates whether system |
| | | includes a plotter |
| logHWSystemModem | Boolean | Indicates whether system |
| | | includes a modem |
| logHWSystemMonitor | Boolean | Indicates whether system |
| | | includes a monitor |
| logHWSystemSpeaker | Boolean | Indicates whether system |
| | | includes speakers |
| logHWSystemJoystick | Boolean | Indicates whether system |
| | | includes a joystick |
| logHWSystemOther | Boolean | Indicates whether system |
| | | includes other hardware |
| txtHWSystemother | Text | Description of other |
| | | hardware in system |
| dtmHWSystemDateAdded | Date/Time | Date hardware in system |
| | | changed |

TABLE 8
tblHardwareType

| Field | Type | Description |
|---|---|---|
| intHWTypeID | Integer | Identification number; key |
| | | field |
| txtHWTypeDescription | Text | Description of system |
| | | hardware |
| txtHWTypeCode | Text | Identification number |
| logHWTypeActive | Boolean | Indicates whether this type |
| | | of system hardware is |
| | | currently insurable |

Although the foregoing discussion has centered on the processing of an application for a policy for a specific type of insurance, the present invention is equally applicable to the processing of an application for a policy of insurance covering multiple types of risks. For example, a policy might cover many of the risks commonly faced by the owner of a home business, which risks might normally be covered by several separate insurance policies, such as property, liability, and accidental death policies. The specific types of risks covered by such a policy would depend on the needs of the particular class of customer sought to be served by the policy and might insure against risks normally covered by any combination of types of policies of insurance now or hereafter available.

The present invention may be embodied in other specific forms without departing from the spirit or essential attributes of the invention. Accordingly, reference should be made to the appended claims, rather than the foregoing specification, as indicating the scope of the invention.

We claim:

1. A method of processing an insurance application, comprising the steps of:
receiving an application for a policy of insurance from a user over a computer network;
automatically approving or denying the application based on a comparison of data contained in the application with stored underwriting criteria;
automatically offering a policy of insurance to the user in response to the application over the computer network if the application is approved and presenting the policy to the user for electronic acceptance; and
issuing the policy upon electronic acceptance thereof by the user,
wherein all of the steps of said method occur during a single user session on the computer network.

2. The method of claim 1, wherein the stored criteria are stored in a database.

3. The method of claim 1, wherein the stored criteria are stored in executable code.

4. The method of claim 1, wherein the applicant is the insured party of the policy and the insured party purchases the policy directly from the issuer thereof.

5. The method of claim 1, further comprising the step of:
receiving a credit card number from the applicant prior to issuance of the policy for use in payment of premiums due in connection therewith.

6. The method of claim 1, wherein the policy of insurance is a policy insuring a computer against loss or damage.

7. The method of claim 1, wherein the policy of insurance is a policy insuring property against loss or damage.

8. The method of claim 1, wherein the policy of insurance is an accidental death policy.

9. The method of claim 1, wherein the policy of insurance is a disability policy.

10. The method of claim 1, wherein the policy of insurance is a major medical policy.

11. The method of claim 1, wherein the policy of insurance is a casualty policy.

12. The method of claim 1, wherein the policy of insurance insures against at least two of loss or damage to property, casualty, accidental death, disability, and medical expense.

13. A method of processing an application for an amendment to an existing policy of insurance, comprising the steps of:
receiving an application for an amendment to a policy of insurance from a user over a computer network;
automatically approving or denying the application based on a comparison of data contained in the application with stored underwriting criteria;
automatically offering an amended policy of insurance to the user in response to the application over the computer network if the application is approved and presenting the amended policy to the user for electronic acceptance; and
issuing the amended policy upon electronic acceptance thereof by the user,
wherein all of the steps of said method occur during a single user session on the computer network.

14. A computerized system for processing an insurance application during a single user session, comprising:
means for receiving an application for a policy of insurance from a user over a computer network during a user session;
means for automatically approving or denying the application during the user session based on a comparison of data contained in the application with stored underwriting criteria;
means for automatically offering a policy of insurance to the user during the user session in response to the application over the computer network if the application is approved and presenting the policy during the user session to the user for electronic acceptance; and
means for issuing the policy during the user session upon electronic acceptance thereof by the user.

15. The system of claim 14, wherein the applicant is the insured party of the policy and the insured party purchases the policy directly from the issuer thereof.

16. The system of claim 14, further comprising:
means for receiving a credit card number from the applicant prior to issuance of the policy for use in payment of premiums due in connection therewith.

17. The system of claim 14, wherein the policy of insurance is a policy insuring a computer against loss or damage.

18. The system of claim 14, wherein the policy of insurance is a policy insuring property against loss or damage.

19. The system of claim 14, wherein the policy of insurance is an accidental death policy.

20. The system of claim 14, wherein the policy of insurance is a disability policy.

21. The system of claim 14, wherein the policy of insurance is a major medical policy.

22. The system of claim 14, wherein the policy of insurance is a casualty policy.

23. A computerized system for processing an insurance application during a single user session, comprising:
a server; and
a database;
wherein said server transmits an application for a policy of insurance to a user over a computer network during a user session in response to a request therefore from the user;
wherein the server automatically approves or denies the application during the user session based on a comparison of data contained in the application with stored underwriting criteria;
wherein said server automatically offers a policy of insurance to the user during the user session in response to the application over the computer network if the application is approved and presents the policy during the user session to the user for electronic acceptance; and
wherein said server issues the policy during the user session upon electronic acceptance thereof by the user.

24. The system of claim 23, wherein the applicant is the insured party of the policy and the insured party purchases the policy directly from the issuer thereof.

25. The system of claim 23, wherein:
said server receives a credit card number from the applicant prior to issuance of the policy for use in payment of premiums due in connection therewith.

26. The system of claim 23, wherein the policy of insurance is a policy insuring a computer against loss or damage.

27. The system of claim 23, wherein the policy of insurance is a policy insuring property against loss or damage.

28. The system of claim 23, wherein the policy of insurance is an accidental death policy.

29. The system of claim 23, wherein the policy of insurance is a disability policy.

30. The system of claim 23, wherein the policy of insurance is a major medical policy.

31. The system of claim 23, wherein the policy of insurance is a casualty policy.

32. A computer-readable medium tangibly embodying instructions which, when executed by a computer, implement a process comprising the steps of:
receiving an application for a policy of insurance from a user over a computer network;
automatically approving or denying the application based on a comparison of data contained in the application with stored underwriting criteria;
automatically offering a policy of insurance to the user in response to the application over the computer network if the
application is approved and presenting the policy to the user for electronic acceptance; and
issuing the policy upon electronic acceptance thereof by the user,
wherein all of the steps of said process occur during a single user session on the computer network.

33. The computer-readable medium of claim 32, wherein the applicant is the insured party of the policy and the insured party purchases the policy directly from the issuer thereof.

34. The computer-readable medium of claim 32, wherein the process further comprises:
receiving a credit card number from the applicant prior to issuance of the policy for use in payment of premiums due in connection therewith.

35. The computer-readable medium of claim 32, wherein the policy of insurance is a policy insuring a computer against loss or damage.

36. The computer-readable medium of claim 32, wherein the policy of insurance is a policy insuring property against loss or damage.

37. The computer-readable medium of claim 32, wherein the policy of insurance is an accidental death policy.

38. The computer-readable medium of claim 32, wherein the policy of insurance is a disability policy.

39. The computer-readable medium of claim 32, wherein the policy of insurance is a major medical policy.

40. The computer-readable medium of claim 32, wherein the policy of insurance is a casualty policy.
